(19) United States
(12) Patent Application Publication
(10) Pub. No.: US 2014/0053928 A1
(43) Pub. Date: Feb. 27, 2014

(54) Double Seat Valve With Secure Closing Function

(71) Applicant: Karl Dungs GmbH & Co. KG, Urbach (DE)

(72) Inventors: Siegfried Berger, Schlierbach (DE); Martin Lang, Nellmersbach (DE); Thomas Amann, Schwabisch Gmund (DE)

(21) Appl. No.: 13/961,098

(22) Filed: Aug. 7, 2013

(30) Foreign Application Priority Data
Aug. 24, 2012 (DE) 10 2012 107 830.0

(51) Int. Cl. F16K 1/44

(52) U.S. Cl. CPC F16K 1/443
USPC 137/614.11

(57) ABSTRACT

In a double seat valve (12), two preferably equally identical valve closure members (18, 20), said members being equally rigidly connected to another, and two preferably equally identical valve seats (19, 21) are provided. The first valve closure member (18) is arranged downstream of the first valve seat (19). The second valve closure member (20) is arranged upstream of the valve seat (21). In doing so, a radially interior sealing zone (37) becomes active on the first valve closure member (18). As opposed to this, a radially exterior sealing zone (38) becomes active on the second valve closure member (20).

### CROSS REFERENCE TO RELATED APPLICATION

The present patent application is based upon and claims the benefit of German patent application no. 102012 107 830.0 filed Aug. 24, 2012.

### FIELD OF THE INVENTION

The invention relates to a double seat valve, in particular for gasses. More specifically, the double seat valve has a secure closing function.

### BACKGROUND OF THE INVENTION

Double seat valves having at least two valve seats and two valve closure members associated therewith have been known. Regarding this, publication DE 195 25 384 C2 discloses a double seat valve with a common drive for the two valve closure members, wherein the two coaxially arranged valves, each being composed of a valve seat and a valve disk, are arranged in series with respect to the flow. In doing so, the two valve closure members or valve disks are arranged upstream of the respectively associate valve seat. Pressure applied to the input side thus is applied to the valve disk pushing against the valve seat and aids in creating a seal. In order to release the valve disk from the valve seat, the valve drive must use a force that results from the area of the valve disk and the pressure differential existing on the valve.

Publication DE 10 2004 004 708 B3 also discloses a double seat valve using magnetic actuation. A first valve comprises a bell-shaped valve closure member that extends over a valve disk. The bell-shaped valve closure member and the valve disk are assigned a common valve seat.

Also in this case, the valve drive must provide a force that ultimately results from the diameter of the valve seat and the gas pressure acting on the valve.

If the force required for opening the valve is to be reduced, a first and a second valve may be arranged in parallel, said valves however being arranged so as to have opposing flow directions and be actuated by the same drive. If, in such a case, it is to be ensured that the two valves that are communicating with each other are biased in closing direction by the input pressure, the two closure members or valve disks must have different diameters. This represents a considerable outlay of time and effort from the viewpoint of design and assembly.

### SUMMARY OF THE INVENTION

It is the object of the invention to implement a double seat valve featuring an independent closing effect with a smaller outlay of design and assembly.

This object is achieved with the double seat valve in accordance with claim 1:

The double seat valve in accordance with the invention comprises a first and a second valve, each comprising a valve seat and a valve closure member. The two valves are arranged parallel to one another with respect to the flow. The two valve closure members are designed so as to be equally configured. In closed state, each of the two valve closure members is in abutment with its respectively associate valve seat. Inasmuch as the first valve is arranged downstream of its valve seat and the second valve closure member is arranged upstream of its valve seat, gas pressure forces acting in opposite directions result on both valve closure members. In addition, different sealing conditions result on the two valves. Whereas the gas pressure (acting in opening direction) acts on the first valve on the interior rim of the valve closure member, the gas pressure (acting in closing direction) acts on the exterior rim in the second valve. In doing so, the two valve closure members define different gasket abutment surfaces, each inhibiting the passage of gas. The two different gasket abutment surfaces circumscribe large different-size active surfaces, as a result of which the forces originating from the gas pressure feature different values on the two valve closure members. The force component acting in an opening manner, said force originating from the downstream valve closure member, is smaller than the force components acting in a closing manner, said forces originating from the upstream second valve closure member. The gas pressure applied to the input side thus supports the closing action of the double seat valve.

The two valve closure members may have equal configuration. The different-size diameters of the two gasket abutment surfaces can be achieved by appropriately different designs of the first and second valve seats. However, it is preferred that both valve seats have equal configuration. Furthermore, it is preferred that not only the first and the second valve seats are equal but that also the first and the second valve closure members have the same configuration. In this case, the first and the second valves have the same design. Nevertheless, different diameters of the annular gasket abutment surfaces are achieved, among other things, in that the flow directions of the first and second valves are defined so as to be opposite each other.

The first valve closure member and the second valve closure member are connected to one another, preferably in a rigid manner, e.g., by a valve spindle, an actuating rod or the like. In so doing, the distance of the valve closure members from one another corresponds to the distance of the valve seats from one another. Consequently, the simultaneous opening and closing of the first and second valves is achieved.

Preferably, the two valve closure members of the two valves have matching gaskets. Preferably, each gasket has an exterior and an interior gasket structure, e.g., in the form of an annular rib. The ribs may have a triangular cross-section, a round cross-section, a tetragonal cross-section, a lip-type structure or another suitable cross-section. Preferably, these project in axial direction and are arranged so as to be concentric to each other.

The first valve seat is preferably formed by a planar surface. Independently thereof, the second valve seat is preferably a planar surface. If the mentioned gasket has two (or more) concentric gasket structures, e.g., annular ribs, both ribs, respectively, are preferably seated on the valve seat along their entire circumference when the first, as well as the second, valve are in closed state. In so doing, the gasket abutment surface is defined by that annular rib that faces the higher gas pressure, i.e., the upstream valve side.

In addition, it is pointed out that the valve seats may also have different configurations. For example, the valve seat may be provided with a simple, annular, axially projecting rib or with two concentric, axially projecting ribs. The gasket of the valve closure member may thus be a planar surface or it may also feature a rib structure. Additional combinations and modifications, in particular combinations of the aforementioned features, are possible.

### IN THE DRAWINGS

FIG. 1 is a schematic representation of a longitudinal section of a valve arrangement comprising two double seat valves;

FIGS. 2 and 3 show details of FIG. 1, each in schematized representations in vertical section;

FIGS. 4 and 5 are a modified embodiment of the double seat valve arrangement as in FIG. 1, in accordance with FIGS. 2 and 3;

FIG. 6 is a double seat valve with different valve seats, in a representation corresponding to FIG. 2; and

FIG. 7 is a further modified embodiment of a double seat valve, in a representation corresponding to FIG. 2.

### DETAILED DESCRIPTION OF THE INVENTION

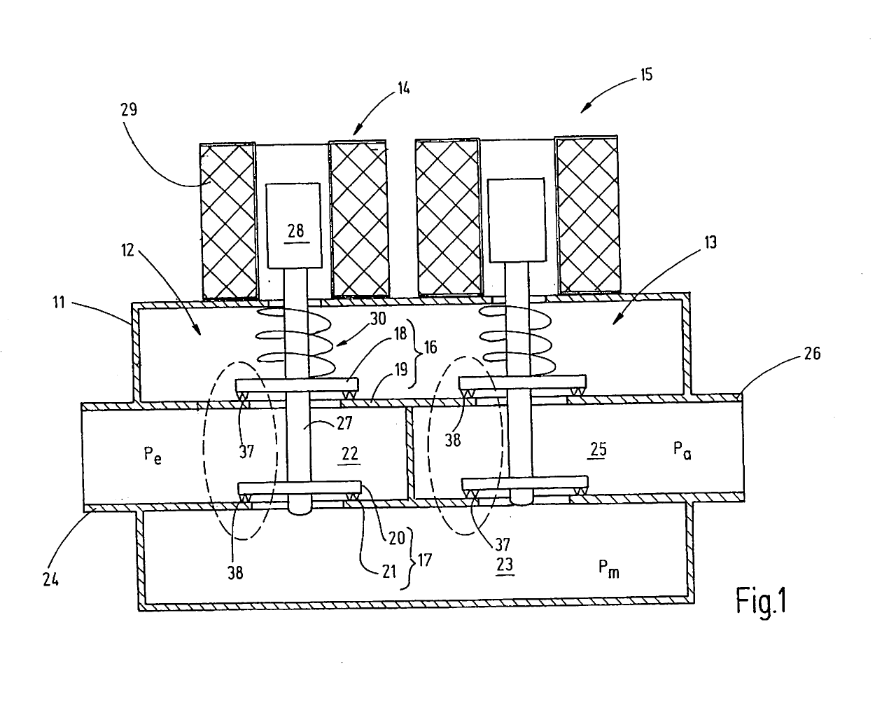

FIG. 1 shows a double seat valve arrangement 10 comprising at least one, preferably, however two, double seat valves 12, 13, accommodated in a housing 11, for example. The two double seat valves 12, 13 may be equally configured. Therefore, the description of the double seat valve 12 hereinafter applies correspondingly to the double seat valve 13. The double seat valves 12, 13 are arranged in series in the direction of flow and thus form a secure valve arrangement. They are associated with individual drives 14, 15, for example in the form of pull-type electromagnet drives or also other drive arrangements.

The double seat valve 12 comprises a first valve 16 and a second valve 17, both being driven by the common drive 14. The first valve 16 comprises a first valve closure member 18 and a first valve seat 19. The second valve 17 comprises a second valve closure member 20 and a second valve seat 21. The two valves 16, 17 delimit an inflow chamber 22 relative to a center chamber 23. The inflow chamber 22 is arranged in flow communication with an input connection 24. The second double seat valve 13 delimits the center chamber 23 relative to an outflow chamber 25, said chamber communicating with an outlet connection 26. An input pressure Pₑ acts on the inlet connection 24 of the double seat valve arrangement 20. A clearly lower output pressure Pₐ acts on the outlet connection 26. A pressure Pₘ acts on the center chamber 23, wherein this pressure corresponds to the input pressure Pₑ or to the output pressure Pₐ or may be in between these.

The first valve closure member 18 and the second valve closure member 20 are rigidly connected to one another, preferably via a valve spindle 27 that communicates with the drive 14. To do so, said valve spindle may be connected to a magnet armature 28 that can be moved in axial direction by a magnet coil 29. Magnetic flow guiding pieces, yokes and the like are usually provided, however, not specifically depicted in FIG. 1.

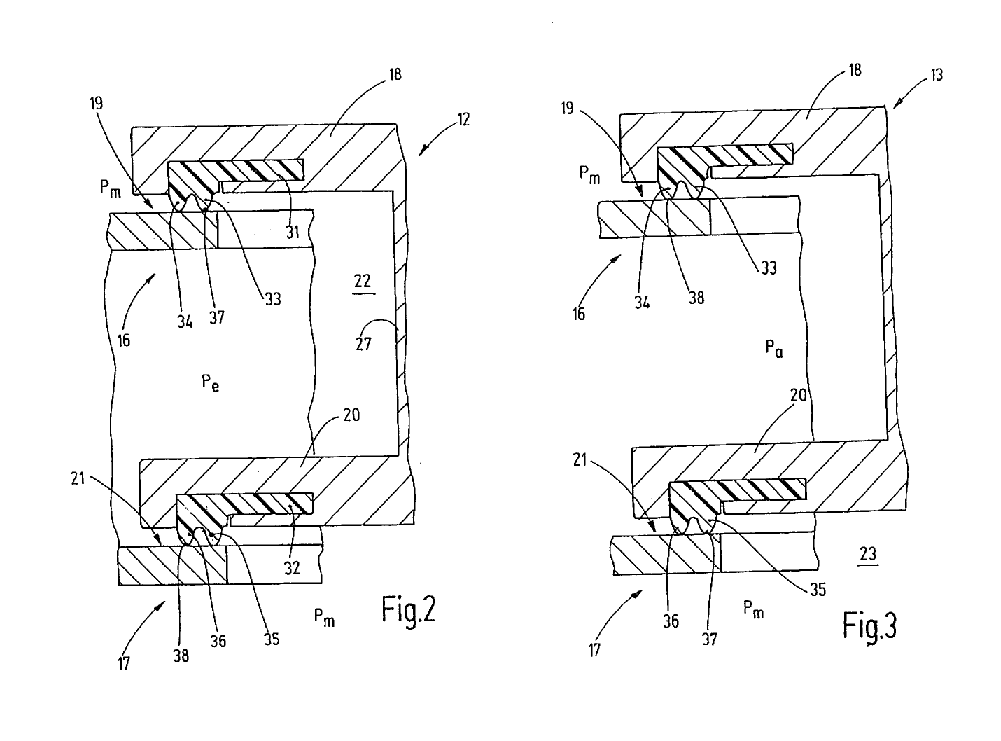

A return spring 30 may be provided concentric to the valve spindle 27, said spring being a pressure spring, for example and acting on the two valves 16, 17 in closing direction. In so doing, the two valve closure members 18, 29 are preferably arranged so as to be concentric to each other and be equally configured. In other words: It is possible to use standardized valve disks for the valves 16, 17. FIG. 2 shows the valves 16, 17 in greater detail. The valve closure member 18 is essentially disk-shaped or plate-shaped. It may also have the form of a bell, funnel or another, preferably rotation-symmetrical, form. An annular gasket 31 is arranged in the vicinity of the exterior rim of said member. A gasket 32 is arranged in the same position on the valve closure member 20. Preferably, the gaskets 31, 32 match the first and the second valve closure members 18, 20.

Preferably, the gasket 31 has two axially projecting circular sealing ribs 33, 34, said ribs having preferably the same height in axial direction. The gasket 31, including its sealing ribs 33, 34, preferably consists of a fluid-tight material such as natural rubber, rubber, an elastomer or the like. The sealing ribs 33, 34 may be arranged so as to be concentric relative to each other.

Preferably, the sealing rib 32 has the same configuration as the sealing rib 31. Likewise, there is an interior sealing rib 35 and an exterior sealing rib 36. Other than that, the description of the gasket 31 applies accordingly to the gasket 32.

The double seat valve 12 described so far operates as follows:

In closed state, the input pressure Pₑ is applied to the inflow chamber 22. This pressure is at least as great as the center pressure Pₘ, however, preferably greater than said center pressure. The gas applied at pressure Pₑ impinges on the first valve 16 on the (radially interior) sealing zone 37 where the interior rib 33 abuts against the preferably planar valve seat 19. Referring to the second valve 17, the gas impinges at the input pressure Pₑ on a (radially exterior) annular sealing zone 38 formed between the exterior sealing rib 36 and the valve seat 21. As is obvious, the sealing zone 37 has a smaller radius or diameter than the second sealing zone 38. The input pressure Pₑ acts on the surface circumscribed by the sealing zone 37 in a manner so as to open the first valve closure member 18. The same input pressure Pₑ acts on the second valve closure member 20 on the larger sealing surface 38 circumscribed by the exterior sealing rib. Inasmuch as the two valve closure members 18, 20 are rigidly connected to one another, overall a differential force remains, said force acting in a closing manner on the unit comprising the two valve closure members 18, 20. This takes place, even though both valve closure members 18, 20 and both valve seats 19, 21 have identical designs.

FIG. 3 shows the conditions existing on the second double seat valve 13. For reasons of simplicity, the reference signs introduced in connection with the double seat valve 12 are used again. In the first valve 16, the sealing zone 38 is formed between the exterior rib 34 and the valve seat 19. The center pressure Pₘ is greater than the output pressure Pₐ.

Consequently, the gas subjected to the pressure Pm first impinges on the exterior sealing rib 34 in the valve 16. In the second valve 17, the gas subjected to the pressure Pm first impinges on the sealing zone 37 formed between the interior rib 35 and the valve seat 21. Now an opening force acts on the valve closure member 20, said force being smaller than the force acting on the valve closure member 18 due to the smaller diameter of the sealing zone 37. The latter force is defined by the larger diameter of the sealing zone 38. The resultant differential force again is a closing force.

A force at rest composed of the gas pressures Pₑ and Pₘ, respectively, said force having a closing effect, occurs in both seat valve arrangements 12, 13 as a result of the respective pressure application and the different flow directions of the valves 16, 17. The different flows through the two valves 17, 18 acting in a flow-parallel manner result from the fact that the valve closure member 18 of the first valve 16 is arranged downstream of the valve seat 19, whereas the valve closure member 20 of the second valve 17 is arranged upstream of the valve seat 21. In the second double seat valve 13, the conditions are similar. In that case, viewed from the center chamber 23, the first valve closure member 18 is arranged upstream and the second valve closure member 20 is arranged downstream. Again, there results a differential force having a closing effect.

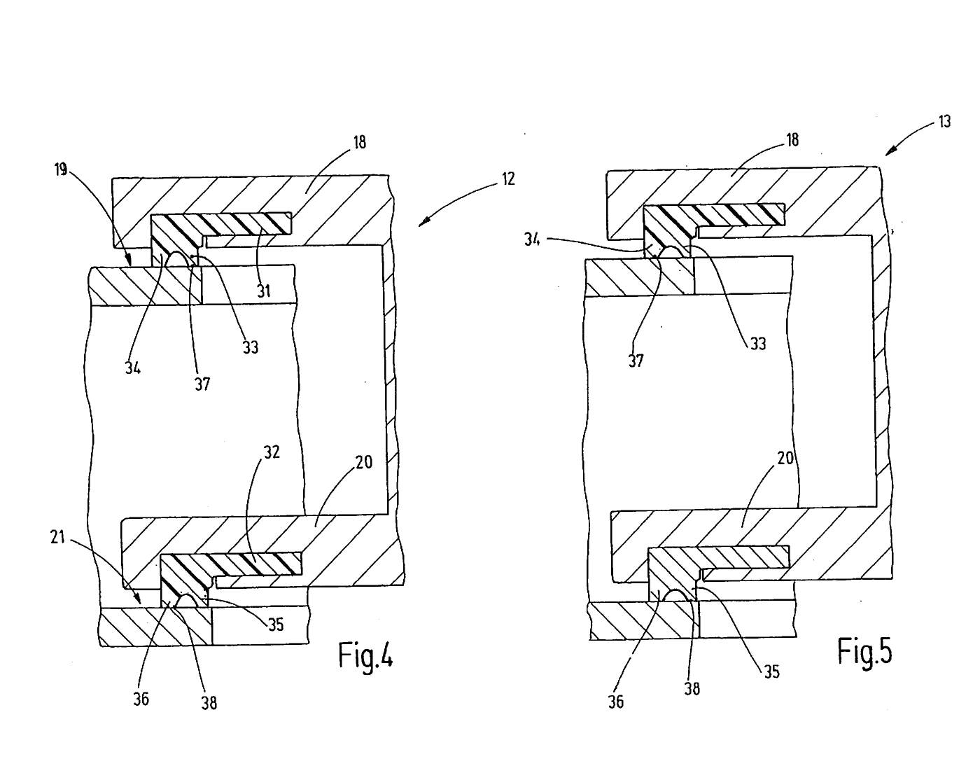

As shown by FIGS. 4 and 5, the valve closure members 18, 20 in the double seat valves 12, 13 may be provided with differently configured gaskets 31, 32. For example, the form of the ribs 33, 34, 35, 36 may have any suitable gasket cross-section. Whereas the sealing ribs 33 through 36 in accordance with FIGS. 2 and 3 may have a rounded profile and thus define essentially linear sealing zones 37, 38, the sealing ribs 33 through 36 in accordance with FIGS. 4 and 5 may also be flat in order to define strip-shaped sealing zones 37, 38.

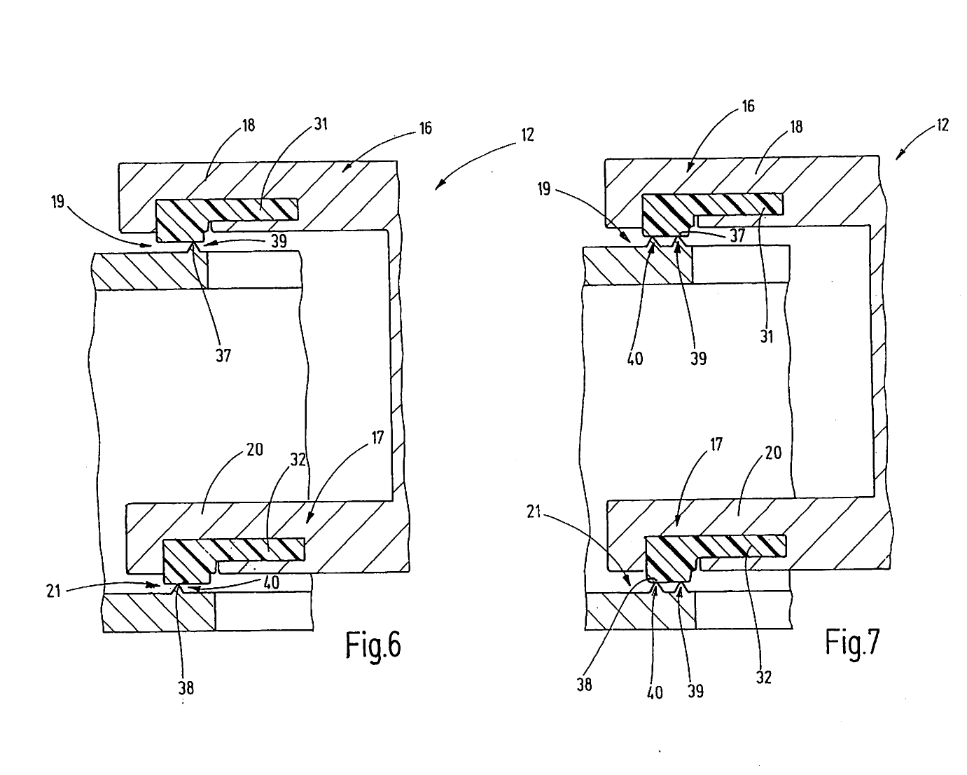

Alternatively, as shown by FIG. 6, the gaskets 31, 32 may also be uniformly flat. In this case, the different sealing zones 37, 38 may be configured as annular, rib-like projections 39, 40 on the valve seats 19, 21, these potentially having a triangular cross-section, for example. The projections 39, 40 may have different diameters in order to provide the sealing zones 37, 38 with different diameters, as desired.

It is also possible to provide the projections with another cross-section, e.g., a rectangular cross-section. Then, the result is a stepped valve seat. In interaction with a valve closure member 18, 20 in accordance with one of the FIGS. 1 through 4, it is achieved that only one of the sealing ribs 33, 34 and 35, 36, respectively, comes into abutment with the valve seat. This may be of interest if only extremely small opening forces are available and the spring closure force must be reduced accordingly. Again, the same components may be used for both valve disks (upper and lower).

As shown by FIG. 7, it is also possible to configure the valve seats 19, 21 in a uniform manner in that each of the two valve seats 19, 21 is provided with both projections 39, 40. In this case, the differing diameters of the sealing zones 37, 38 are again obtained—as has already been explained in conjunction with FIGS. 2 and 3—from the different arrangement of the two valve closure members 18, 20 relative to the respective valve seat 19, 21 (upstream or downstream) and thus as a function of the location of the gasket 31, 32 (interior or exterior) where the gas pressure is blocked.

In a double seat valve 12, two preferably equally identical valve closure members 18, 20, said members being equally rigidly connected to one another, and two preferably equally identical valve seats 19, 21 are provided. The first valve closure member 18 is arranged downstream of the first valve seat 19. The second valve closure member 20 is arranged upstream of the valve seat 21. In doing so, a radially interior sealing zone 37 becomes active on the first valve closure member 18. As opposed to this, a radially exterior sealing zone 38 becomes active on the second valve closure member 20. Due to the differently sized surfaces circumscribed by the sealing zones 37, 38, different axial forces are generated on the two valve closure members 18, 20, said axial forces superimposing to create a total closing force. Despite the use of uniform components for both valves 16, 17, a resultant closing force is created on both valves 16, 17.

### LIST OF REFERENCE SIGNS

10 Double seat valve arrangement
11 Housing
12, 13 Double seat valves
14, 15 Drive
16 First valve
17 Second valve
18 First valve closure member
19 First valve seat
20 Second valve closure member
21 Second valve seat
22 Inflow chamber
23 Center chamber
24 Inlet connection
25 Outflow chamber
26 Outlet connection
27 Valve spindle
28 Magnet armature
29 Magnet spindle
30 Return spring
31 Gasket of the first valve closure member 18
32 Gasket of the second valve closure member 20
33 Interior sealing rib of the gasket 31
34 Exterior sealing rib of the gasket 31
35 Interior sealing rib of the gasket 32
36 Exterior sealing rib of the gasket 32
37 Sealing zone
38 Sealing zone
39 Projection of the valve seat 19
40 Projection of the valve seat 21

The above detailed description of the present invention is given for explanatory purposes. It will be apparent to those skilled in the art that numerous changes and modifications can be made without departing from the scope of the invention. Accordingly, the whole of the foregoing description is to be construed in an illustrative and not a limitative sense, the scope of the invention being defined solely by the appended claims.

1. Double seat valve (12) comprising
a first valve (16) comprising a first valve seat(19) and a first valve closure member(18) arranged downstream of said first valve seat, said valve closure member defining, with the first valve seat (19), a first annular gasket abutment surface (37),
a second valve (17)comprising a second valve seat (21) and a second valve closure member (20) arranged upstream of said valve seat, said valve closure member defining, with the second valve seat (21), a second annular gasket abutment surface (38),
wherein the first valve closure member (18) and the second valve closure member (20) are equally connected to one another, and wherein the first gasket abutment surface (37) circumscribes a surface that is smaller than the surface that is circumscribed by the second gasket abutment surface (38),
wherein the first valve closure member 18) and the second valve closure member (20) are equally configured.]

2. Double seat valve as in claim 1, characterized in that the first valve (16) and the second valve (17) are designed so as to be equally configured.

3. Double seat valve as in claim 1, characterized in that the first valve closure member (18) and the second valve closure member (20) communicate with one another via a valve spindle (27).

4. Double seat valve as in claim 1, characterized in that the first valve closure member (18) and the second valve closure member (20) are axially equally rigidly connected to one another.

5. Double seat valve as in claim 1, characterized in that matching gaskets (31, 32) are arranged on the valve closure members (18, 20).

6. Double seat valve as in claim 5, characterized in that each gasket (31, 32) has an interior sealing structure (33, 35) and an exterior sealing structure (34, 36).

7. Double seat valve as in claim 6, characterized in that the sealing structures (33, 34, 35, 36) consist of annular, axially projecting ribs.

8. Double seat valve as in claim 1, characterized in that a first valve seat (19) and a second valve seat (21) are formed by annular surfaces.

9. Double seat valve as in claim 1, characterized in that a first valve seat (19) and a second valve seat (21) are formed by annular, planar surfaces.

10. Double seat valve as in claim 1, characterized in that a first valve seat (19) and a second valve seat (21) are equally configured.

11. Double seat valve as in claim 1 characterized in that the first valve closure member (18) is arranged downstream of a first valve seat (19).

12. Double seat valve as in claim 1 characterized in that the second valve closure member (20) is arranged upstream of a valve seat (21).

13. Double seat valve as in claim 11 characterized in that a radially interior sealing zone (37) becomes active on the first valve closure member (18).

14. Double seat valve as in claim 12 characterized in that a radially exterior sealing zone (38) becomes active on the second valve closure member (20).
